(19) United States
(12) Patent Application Publication
(10) Pub. No.: US 2025/0302108 A1
(43) Pub. Date: Oct. 2, 2025

(54) A HEATER ASSEMBLY FOR AN AEROSOL GENERATING SYSTEM

(71) Applicant: Philip Morris Products S.A., Neuchatel (CH)

(72) Inventor: Enrico TURRINI, Neuchatel (CH)

(73) Assignee: Philip Morris Products S.A., Neuchatel (CH)

(21) Appl. No.: 18/855,351

(22) PCT Filed: May 4, 2023
(86) PCT No.: PCT/EP2023/061855

§ 371 Date: Oct. 9, 2024

(30) Foreign Application Priority Data
May 6, 2022 (EP) 22172080.8

(51) Int. Cl. A24F 40/465; A24F 40/10; A24F 40/42; A24F 40/44; A24F 40/60; H05B 3/34

(52) U.S. Cl. CPC A24F 40/465; A24F 40/10; A24F 40/42; A24F 40/44; A24F 40/60; H05B 3/34

(57) ABSTRACT

An aerosol-generating system for generating an aerosol from an aerosol-generating substrate is provided, the aerosol-generating system including: a heating element; a receiving chamber at least partially defined by the heating element; a wicking element received in the receiving chamber, the receiving chamber having a first configuration and a second configuration, an internal volume of the receiving chamber being larger when the receiving chamber is in the first configuration than when the receiving chamber is in the second configuration, and, in the second configuration, the heating element is in contact with the wicking element; and an actuator including a user interface element and an actuator, the actuator being configured to actuate the receiving chamber between the first configuration and the second configuration in response to an input on the user interface element. A method of operating the aerosol-generating system is also provided.

The present disclosure relates to an aerosol-generating system and methods of using and controlling the aerosol-generating system. In particular, the present disclosure relates to an aerosol-generating system comprising a wicking element received in a receiving chamber, the receiving chamber having a first configuration and a second configuration.

Aerosol-generating systems configured to generate an aerosol from an aerosol-forming substrate, such as a tobacco-containing substrate, are known in the art. Many known aerosol-generating systems generate aerosol by the application of heat to the substrate by a heater assembly. In electrically operated aerosol-generating systems, heat is applied to the substrate when the heater assembly is supplied with power from a power supply. The generated aerosol can then be inhaled by a user of the device.

In many aerosol-generating devices, a heater element of the heater assembly is configured to heat a quantity of aerosol-forming substrate contained in a porous material such as a wick or capillary element provided adjacent to or in contact with the heater element. The porous material can transport aerosol-forming substrate in liquid form from a reservoir provided in the aerosol-generating system. In this way, aerosol-generating substrate in the vicinity of the heater element that is vaporised during use of the aerosol-generating system is continuously replenished.

Efficient heating of aerosol-forming substrate contained in the porous material is desirable to reduce the power requirements of the heater assembly. This is particularly important when the aerosol-generating system is portable and comprises a portable supply such as a battery. Heating of the aerosol-forming substrate contained in the porous material may be efficient when there is direct contact between the porous material and the heater element. An example of such a heater assembly comprises a resistive heating element in the form of a coil of wire wrapped around a wick. At least one end of the wick extends into a reservoir of aerosol-forming substrate.

One problem with aerosol-generating systems in which a heater element is in direct contact with a porous material, such as a coil and wick type arrangement, is that, over the course of many heating cycles, the porous material can degrade. Degradation can be caused by heating of the porous material. Degradation can also be caused by chemical interactions between the aerosol-forming substrate and the porous material, mechanical stress on the porous material and particle accumulations on the surface of the porous material. Degradation of the porous material can result in less efficient heat transfer between the heating element and the porous material and less efficient transfer of liquid from the reservoir towards the heater element by the porous material. As such, the porous material has a limited useful lifetime. The useful lifetime of the porous material is typically significantly shorter than the lifetime of other components of the aerosol-generating system, for example the heater element. It is not typically possible to replace a degraded porous material without taking the system, and the heater assembly, apart. This is not something that a normal consumer is capable of doing or is inclined to do.

Some aerosol-generating systems comprise a reusable aerosol-generating device and a disposable cartridge. The disposable cartridge comprises the aerosol-forming substrate and, when the aerosol-forming substrate is depleted, the cartridge can be replaced. Such cartridges can comprise the heater element and the porous material, for example the cartridge can comprise a coil and wick type arrangement. In such cases, the heater element and the porous material are disposed of along with the rest of the cartridge when the aerosol-forming substrate of the cartridge is depleted.

When the porous material is provided in a disposable cartridge, it will generally be disposed of and replaced before significant degradation as occurred. However, including both the heater element and the porous material in the cartridge increases the material cost of the cartridge and the complexity of the cartridge.

More generally, high speed manufacturing of a heater element and porous material provided together and in contact with one another is difficult with at least some of the steps of the manufacturing process required to be performed by hand. In particular, high speed manufacturing of coil and wick-type arrangements is difficult. This further increases the cost of manufacturing cartridges comprising a heater element and porous material.

It would be desirable to provide an aerosol-generating system in which efficient heating of an aerosol-forming substrate contained in a porous material is achieved during use. It would be desirable to provide such a heater assembly wherein degradation of components of the system, in particular the heater assembly and the porous material, is reduced compared to prior art systems, particularly compared to coil and wick type arrangements. It would further be desirable to provide an aerosol-generating system in which the porous material is replaceable once it has degraded. In the context of aerosol-generating system comprising a disposable cartridge, it would be desirable to provide an aerosol-generating system in which the porous material is replaceable without increasing the cost and complexity of the cartridge.

According to a first aspect of the present disclosure there is provided an aerosol-generating system for generating an aerosol from an aerosol-generating substrate. The aerosol-generating system may comprise a heating element. The aerosol-generating system may comprise a receiving chamber. The receiving chamber may be at least partially defined by the heating element. The aerosol-generating system may comprise a wicking element. The wicking element may be received in the receiving chamber.

The receiving chamber may have a first configuration. The receiving chamber may have a second configuration. An internal volume of the receiving chamber may be larger when the receiving chamber is in the first configuration than when the receiving chamber is in the second configuration. In the second configuration, the heating element may be in contact with the wicking element.

The receiving chamber having the first and second configuration may advantageously provide a simple and effective means by which the heating element can be coupled or decoupled from a wicking element. By providing two configurations in this way, the heating element need not always be in contact with the wicking element.

When the receiving chamber is in the second configuration the contact between the heating element and the wicking element may advantageously provide for efficient heating of the wicking element by the heating element. Aerosol-forming substrate contained in the wicking element may be heated efficiently when the receiving chamber is in the second configuration. Efficient heating may advantageously be achieved because the contact between the heating element and the wicking element allows for heat conduction. Furthermore, the contact between the heating element and the wicking element may draw liquid out of the wicking element to the heating element.

When the receiving chamber is in the first configuration, the wicking element may be receivable and removable from the receiving chamber. The internal volume of the receiving chamber being larger when the receiving chamber is in the first configuration may advantageously mean that the heating element is not in contact with the wicking element in the first configuration of the receiving chamber such that the heating element is not coupled to the wicking element and the wicking element is removable. As such, the wicking element may advantageously be replaceable. Preferably, the wicking element may be replaced when it is degraded. In particular, the wicking element may advantageously be replaceable when the receiving chamber is in the first configuration without the need to disassemble the aerosol-generating system.

Providing a heater assembly which can be coupled and uncoupled from a wicking element may advantageously reduce degradation of at least one of the heating element and the wicking element received in the receiving chamber.

Degradation of the heating element and the wicking element may be caused by contact between the at least one heating element and the wicking element received in the receiving chamber of the heater assembly. A heater assembly comprising a receiving chamber having the first and second configurations may allow for reduced contact between the at least one heating element and a wicking element received in the receiving chamber compared to a heater assembly in which there is permanent contact between a heating element and a wicking element. This may reduce the degradation of the wicking element.

For example, the receiving chamber may be placed in the second configuration only during use of the aerosol-generating system when the heating element is used to heat the wicking element. Otherwise, the receiving chamber may be placed in the first configuration. In this way, the heating element may be in contact with the wicking element only during heating of the wicking element to ensure efficient heating of the wicking element is achieved. This may significantly reduce the length of time that there is contact between the heating element and the wicking element. This may advantageously extend the lifetime of the wicking element.

The aerosol-generating system may comprise a reservoir. The reservoir may contain an aerosol-forming substrate in condensed form. The wicking element may be couplable to the reservoir to be in fluidic communication with the aerosol-forming substrate in the reservoir.

The aerosol-generating system may comprise an aerosol-generating device. The aerosol-generating device may comprise the heating element. The aerosol-generating device may comprise the receiving chamber.

The aerosol-generating device may comprise the wicking element.

The heating element may be moveable or deformable to reduce the internal volume of the receiving chamber in the second configuration relative to the first configuration. The heating element may be moved or deformed in the second configuration relative the first configuration so as to contact the wicking element.

The aerosol-generating system may comprise an actuator. The actuator may be configured to move or deform the heating element for transition of the receiving chamber from the first configuration to the second configuration. The actuator may be configured to move or deform the heating element to reversibly configure the receiving chamber between the first configuration and the second configuration.

The receiving chamber may be configured such that the wicking element is insertable and removable from the receiving chamber along a longitudinal direction. The longitudinal direction may define a central axis through the receiving chamber.

At least a first portion of the heating element may be closer to the central axis in the second configuration than in the first direction.

At least a first component of the motion of the first portion of the heating element when the heating element is moved or deformed may be perpendicular to the longitudinal direction. The actuator may be configured such that the first component of the motion of the first portion of the heating element may be towards the central axis when the receiving chamber is transitioned from the first configuration to the second configuration.

The heating element may comprise a second portion different to the first portion. In the second configuration of the receiving chamber, the second portion of the heating element may not be contact with the wicking element.

The second portion of the heating element may comprise or consist of material having a resistivity that is lower than the resistivity of a material of the first portion of the heating element. Providing such a material may advantageously result in the second portion of the heating element having a lower resistance per unit length than the first portion of the heating element. The second portion of the heating element may comprise a coating. The coating may comprise a material having a resistivity that is lower than the resistivity of a material of the first portion of the heating element.

The second portion of the heating element may have a cross-sectional area that is larger than the first portion. This may advantageously result in the second portion of the heating element having a lower resistance per unit length than the first portion of the heating element. In such cases, the second portion of the heating element may consist of the same material or materials as the first portion of the heating element.

In the first configuration, the receiving chamber may be configured such that the wicking element is freely removable or receivable within the receiving chamber. This may be achieved as a result of the heating element not contacting the wicking element received in the receiving chamber when the receiving chamber is in the first configuration.

In the second configuration, the receiving chamber may be configured to apply a retaining force on the wicking element. The retaining force may be at least partially applied by the heating element. The retaining force may advantageously ensure that there is contact between the heating element and the wicking element to provide efficient heating.

The heating element may comprise or consist of a resilient material. This may be particularly advantageous when the heating element is deformable to reduce the internal volume of the receiving chamber. The heating element may be deformed in the second configuration relative to the first configuration. A heating element comprising or consisting of a resilient material may advantageously return to the shape of the first configuration when released from the second configuration.

The internal volume of the receiving chamber may be at least 5% larger, preferably at least 10% larger, preferably at least 15% larger, preferably at least 20%, even more preferably at least 30% and even more preferably at least 50% larger when the receiving chamber is in first configuration than when the receiving chamber is in the second configuration.

Preferably, the receiving chamber has an axisymmetric shape, at least in the first configuration. The axis of symmetry of the axisymmetric shape is preferably the central axis that is parallel to the longitudinal direction. Preferably, the receiving chamber is cylindrical in at least the first configuration.

The receiving chamber may have an axis symmetric shape in the second configuration. The axis of symmetry of the axisymmetric shape is preferably the central axis that is parallel to the longitudinal direction. Preferably, the receiving chamber is cylindrical the second configuration.

At least in the first configuration, the receiving chamber may have a width of between 1 millimeter and 12 millimeters, preferably between 3 millimeters and 7 millimeters. If the receiving chamber is cylindrical, the values for the width correspond to values for the diameter of the cylindrical chamber.

A cross-sectional dimension of the receiving chamber may be larger when the when the receiving chamber is in first configuration than when the receiving chamber is in the second configuration. The cross-sectional dimension may be a cross-sectional area or a width of a cross-section of the receiving chamber. When the receiving chamber is cylindrical, the cross-sectional dimension may be the diameter or radius of the receiving chamber.

The cross-sectional dimension may be a dimension of a cross-section of the receiving chamber that is perpendicular to the longitudinal direction.

The heating element may comprise a coil. The coil may be wound around the central axis. The receiving chamber may be at least partially defined by the coil.

The coil may have an electrical resistance of between 0.4 ohms to 4 ohms.

The coil may be formed by a coil of wire. The wire may have a diameter of between 0.1 millimeters and 1 millimeter, preferably between 0.2 millimeters and 0.5 millimeters. The length of the wire may be between 10 millimeters and 150 millimeter, preferably between 20 millimeter and 50 millimeter.

The cross-sectional dimension may be a dimension of a cross-section of the receiving chamber that is perpendicular to the longitudinal direction.

The heating element may comprise a coil. The coil may be wound around the central axis. The receiving chamber may be at least partially defined by the coil.

The coil may have an electrical resistance of between 0.4 ohms to 4 ohms.

The coil may be formed by a coil of wire. The wire may have a diameter of between 0.1 millimeters and 1 millimeter, preferably between 0.2 millimeters and 0.5 millimeters. The length of the wire may be between 10 millimeters and 150 millimeter, preferably between 20 millimeter and 50 millimeter.

The first and second ends of the heating element may further comprise or form one or more contact portions. The first and seconds ends of the heating element may not be in the shape of a coil.

The first and second contact portions may advantageously be mechanically connected to, or connectable to, the actuation means. The actuation means may be configured to deform the heating element by manipulating the first and second contact portions.

Preferably, the first and second contact portions are electrical contact portions. The first heater element may advantageously be connectable to a power supply via the first and second electrical contact portions. The power supply may be external to the heater assembly. For example, an aerosol-generating device that comprises the heater assembly may also comprise the power supply.

The first end of the heating element may be moveable relative to the second end of the heating element to reduce the internal volume of the receiving chamber in the second configuration relative to the first configuration. Preferably, the first end of the heating element may be rotatable relative to the second end of the heating element to reduce the internal volume of the receiving chamber in the second configuration relative to the first configuration. The first end of the heating element may be rotatable about the central axis relative to the second end of the heating element.

The receiving chamber may be at least partially defined by the coil of the heating element. Rotation of the first end relative to the second end of the heater element may deform the coil.

The coil may be a helical coil. The helical coil may be axially symmetric about a helical axis. The helical axis may be parallel to the central axis. The helical axis may, preferably, be the central axis. The helical coil may have a circular cross-section.

The diameter of the coil may be larger when the coil is in the first configuration than when the coil is in the second configuration. The cross-section of the coil may be a cross-section that is perpendicular to the helical axis of the coil.

The pitch of the coil may be larger when the coil is in the first configuration than when the coil is in the second configuration.

As used herein, the “pitch” of the helical coil is the length of one complete helix turn, measured along the helical axis of the helical coil.

The total number of turns of the coil may be smaller when the receiving chamber is in the first configuration than when the receiving chamber is in the second configuration. The total number of turns of the coil may increase by a non-integer number of turns between the first and second configurations of the receiving chamber. The total number of turns may increase by a fraction of one turn between the first and second configurations of the receiving chamber.

The number of turns per unit length of the coil may be smaller when the coil is in the first configuration than when the coil is in the second configuration.

The length of the coil may be substantially the same when the coil is in the first configuration as when the coil is in the second configuration. In other words, the distance between the first end and the second end of the coil along the central axis may be substantially the same when the receiving chamber is in both the first configuration and the second configuration.

The actuator of the aerosol-generating system may be configured to move or rotate the first end of the coil relative to the second end of the coil for transition of the receiving chamber between the first configuration to the second configuration. Preferably, the actuator may be configured to move or rotate the first and second contact portions of the heating element which, in turn, causes movement or rotation of the first and second ends of the coil which are connected to the first and second contact portions respectively.

The helical coil may be a left-handed helical coil or a right-handed helical coil. As used herein, whether the helical coil is “left-handed” or “right-handed” is defined along the length of the central axis in a direction from the first end to the second end of the heating element.

When the helical coil is left-handed, the actuator may be configured to rotate the first end of the coil relative to the second end of the coil in a clockwise direction for transition of the receiving chamber from the first configuration to the second configuration. The actuator may additionally or alternatively be configured to rotate the second end of the coil relative to the first end of the coil in a counter-clockwise direction for transition of the receiving chamber from the first configuration to the second configuration.

When the helical coil is right-handed, the actuator may be configured to rotate the first end of the coil relative to the second end of the coil in a counter-clockwise direction for transition of the receiving chamber from the first configuration to the second configuration. The actuator may additionally or alternatively be configured to rotate the second end of the coil relative to the first end of the coil in a clockwise direction for transition of the receiving chamber from the first configuration to the second configuration. This results in an increase in the number of turns (although the increase may be less than one full turn).

The heating element may comprise spaces configured to allow air to pass through the heating element, at least when the receiving chamber is in the second configuration. The spaces may advantageously allow vaporized aerosol-forming substrate to escape the wicking element received in the receiving chamber during use of the heater assembly. When the heating element is a helical coil, the spaces may be defined between sequential turns of the helical coil, at least when the receiving chamber is in the second configuration.

The aerosol-generating system may comprise a housing. The heating element may be at least partially contained within the housing. At least a portion of the heating element may be surrounded by the housing. The housing may form a hollow body containing at least a portion the heating element. The heating element may be completely contained within the housing.

The actuator may comprise a user interface element and an actuation mechanism. The actuation mechanism may be configured to actuate the receiving chamber between the first configuration and the second configuration in response to an input on the user interface element.

The actuation mechanism may be configured to convert a motion of the user interface during an input to move or deform the heating element. Preferably, the user interface may be moveable between a first position and a second position. The actuation mechanism may be configured such that movement of the user interface from the first position to the second position transitions the receiving chamber from the first configuration to the second configuration. The actuation mechanism may further be configured such that the movement of the user interface from the second position to the first position transitions the receiving chamber from the second configuration to the first configuration.

The actuation mechanism may comprise a portion of the housing. The housing may comprise a first portion and a second portion. At least the first portion of the housing may form the user interface element. The first portion of the housing may be moveable relative to the second portion. Preferably, the first portion of the housing may be rotatable relative to the second portion. Even more preferably, the first portion of the housing may be rotatable relative to the second portion about the central axis. Advantageously, rotation of the first portion of the housing relative to the second portion of the housing may move or deform the heating element for transition of the receiving chamber between the first and second configurations.

Alternatively, the actuator may be electrically operated and controlled by control circuitry. The control circuitry may be configured to control the actuator for transition of the receiving chamber from the first position to the second position, or from the second position to the first position, as required. For example, at the start of a usage session of the device, a user may activate the system. Activation may comprise a user pressuring a button or other user interface element of the device. Activation may alternatively comprise a user drawing air through a mouthpiece of the system which may be detected by a puff detector arrangement. The control circuitry may be configured for transition of the receiving chamber from the first position to the second position on activation of the device. The control circuitry may also be configured to supply power to the heater assembly.

The control circuitry may be configured for transition of the receiving chamber from the second position to the first position at the end of a usage session or when the device is otherwise deactivated.

As above, the heating element may comprise a coil wound around a central axis and further comprise a first end and a second end with the coil defined between the first end and the second end. The first end of the coil may be engaged to the first portion of the housing. Preferably, the first end of the heating element may be permanently fixed to the first portion of the housing. A second end of the heating element may be engaged to the second portion of the housing. Preferably, the second end of the heating element may be permanently fixed to the second portion of the housing.

Engaging or permanently fixing the coil at the first and second ends to the housing may advantageously constrain the heating element so that rotation of the first portion of the housing relative to the second portion deforms the heating element to reduce the internal volume. This may be because rotational motion of the first portion of the housing relative to the second portion of the housing may be transferred to first heating element so that the first end of the heating element is rotated relative to the second end of the heating element for transition of the receiving chamber between the first configuration to the second configuration. Furthermore, the separation of the first end of the heating element relative to the second end of the heating element along the central axis may be maintained as substantially constant in both the first and second configurations. As such, the length of the coil may be maintained substantially constant in the both first and second configurations. Thus, the rotation of the two ends of the heating element relative to one another may change the diameter, pitch and number of turns per unit length of a helical coil.

Whether the rotation of the housing transitions the receiving chamber between the first configuration and second configuration will depend on whether coil is left or right handed and the direction that the first portion of the housing is rotated relative to first portion of the housing.

Preferably, the coil may be not be engaged or fixed to the housing other than at the first end and at the second end. In this way, the coil may advantageously be free to deform between the first and second ends.

In the first configuration, the coil of the heating element may be in contact with the housing along the length of the coil.

In the second configuration, the coil of the heating element may not be in contact with the housing. In the second configuration, the heating element may not be in contact with the housing other than at the first and second ends.

At least when the receiving chamber is in the second configuration, an airflow path may be defined between the housing and the heating element. The receiving chamber may be at least partially defined by a first side of the heating element. The airflow path may be at least partially defined on a second side of the heating element, opposite the first side, at least when the receiving chamber is in the second configuration.

At least when the receiving chamber is in the second configuration, an aerosol-generating chamber may be defined between the heating element housing and the heating element. Therefore the heater assembly may comprise a heating chamber, the heating chamber comprising the receiving chamber and the aerosol-generating chamber.

When the heating element comprises a coil, the receiving chamber may be defined on be an inner surface of the coil. So, if the coil is a helical coil with a cylindrical cross-section, the receiving chamber may be cylindrical also. The airflow path may be at least partially defined on an outer surface of the coil, opposite the inner surface of the coil, at least when the receiving chamber is in the second configuration.

In an alternative embodiment, the heating element may comprise a planar portion. A normal of the plane of the planar portion may be perpendicular to at least one of the longitudinal direction or central axis.

The planar portion may be in the form of a sheet. The heating element may be fluid permeable. The heating element may comprise a plurality of electrically conductive filaments, a mesh or a sheet comprising a plurality of holes.

The heating element comprising a planar portion may be moveable to reduce the internal volume of the receiving chamber in the second configuration relative to the first configuration. The heating element may be moveable in a direction perpendicular to a longitudinal direction along which the wicking element is receivable in the receiving chamber.

The heater assembly may comprise an actuator. The actuator may be configured to move the heating element for transition of the receiving chamber from the first configuration to the second configuration.

The heater assembly has been described as comprising a heating element. As such, the heater assembly may comprise further heating elements. For example, the heater assembly may comprise a second heating element. The heater assembly may comprise a third heating element. The heater assembly may comprise a fourth heating element.

Each of the heating elements may have features corresponding to the features of the heating element. For example, each of the heating elements may be in contact with the wicking element when the receiving chamber is in the second configuration. Each of the heating elements may be moveable or deformable to reduce the internal volume of the receiving chamber in the second configuration relative to the first configuration. An actuator of the aerosol-generating system may be configured to move or deform each of the heating elements for transition of the receiving chamber from the first configuration to the second configuration.

When the heating element comprises a coil, one or more of the further heating elements may also comprise a coil having a corresponding features to the coil of the heating element. For example, the one or more further heating element may each comprise a coil, a first end and a second end. Each coil may be a helical coil.

In other words, the heater assembly may comprise a plurality of coils.

The helical axis of each of the plurality of coils may be parallel to one another. The helical axis of each of the plurality of coils may be the central axis.

One or more of the plurality of coils may overlap with another.

The plurality of coils may be distributed along the central axis. The plurality of coils may be spaced apart along the length of the central axis.

As used herein, the term “aerosol-generating device” is used to describe a device that interacts with an aerosol-forming substrate of an aerosol-generating article to generate an aerosol. Preferably, the aerosol-generating article is a cartridge.

As used herein, the term “aerosol-forming substrate” denotes a substrate consisting of or comprising an aerosol-forming material that is capable of releasing volatile compounds upon heating to generate an aerosol.

As used herein, the term “aerosol-forming material” denotes a material that is capable of releasing volatile compounds upon heating to generate an aerosol. An aerosol-forming substrate may comprise or consist of an aerosol-forming material.

The aerosol-generating system may comprise a power supply. It may be the aerosol-generating device that comprises the power supply. The power supply may be contained in the device housing. The power supply may be electrically connectable to the at least first heating element. When the heating element comprises a coil wound around a central axis and a first end and a second end, the power supply may be connected to or connectable to electrical contact portions fixed to the first end and second end.

The power supply may be a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts). The power supply may be a battery, such as a rechargeable lithium ion battery. Alternatively, the power supply may be another form of charge storage device such as a capacitor. The power supply may be rechargeable. The power supply may have a capacity that allows for the storage of enough energy for one or more uses of the aerosol-generating device. For example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations.

The heating element may be a resistive heating element. The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composition materials made of ceramic material and a metallic material. Such composite materials may comprise doped and undoped ceramics.

The power supply may be configured to supply current to the resistive heating element in use.

An aerosol-generating device comprising a resistive heating element may be described as a resistively heated aerosol-generating device.

Alternatively, the aerosol-generating device may be an inductively heated aerosol-generating device. An inductively heated aerosol-generating device may comprise an inductor coil. The inductor coil may be connected to or connectable to the power supply.

When the aerosol-generating device comprises an inductor coil, the aerosol-generating device may be configured to supply an alternating current to the inductor coil. The alternating current may have any suitable frequency. The alternating current may preferably be a high frequency alternating current. The alternating current may have a frequency between 100 kilohertz (kHz) and 30 megahertz (MHz). In use, the alternating current supplied to the inductor coil may generate an changing magnetic field.

When the power supply is configured to supply an alternating current the aerosol-generating device may advantageously comprise a direct current to alternating current (DC/AC) inverter for converting a DC current supplied by the DC power supply to an alternating current. The DC/AC converter may comprise a Class-D or Class-E power amplifier. The power supply may be configured to provide the alternating current.

The inductor coil may surround or be adjacent to the at least first heating element of the heater assembly. In such cases, the heating element may be a susceptor element.

As used herein, a “susceptor” or “susceptor element” means a conductive element that heats up when subjected to the changing magnetic field generated by the inductor coil. This may be the result of eddy currents induced in the susceptor element or hysteresis losses (or both eddy currents induced in the susceptor element and hysteresis losses). Possible materials for the susceptor include graphite, molybdenum, silicon carbide, stainless steels, niobium, aluminium and virtually any other conductive elements.

The aerosol-generating device may comprise a controller. The controller may be a microprocessor, which may be a programmable microprocessor, a microcontroller, or an application specific integrated chip (ASIC) or other electronic control circuitry. The controller may be configured to regulate the supply of power from the power supply to the heater assembly.

The wicking element may have a fibrous or spongy structure. The wicking element preferably comprises a bundle of capillaries. For example, the wicking element may comprise a plurality of fibres or threads or other fine bore tubes. The fibres or threads may be generally aligned to convey liquid to the heater. Alternatively, the wicking element may comprise sponge-like or foam-like material. The structure of the wicking element may form a plurality of small bores or tubes, through which the liquid can be transported by capillary action. The wicking element may comprise any suitable material or combination of materials. Examples of suitable materials are a sponge or foam material, ceramic- or graphite-based materials in the form of fibres or sintered powders, foamed metal or plastics material, a fibrous material, for example made of spun or extruded fibres, such as cellulose acetate, polyester, or bonded polyolefin, polyethylene, terylene or polypropylene fibres, nylon fibres or ceramic. The wicking element may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary device by capillary action.

Preferably, the wicking element may be a ceramic wick. The ceramic wick may comprise, or preferably consist of, a ceramic material. Preferably, when the wicking element is a ceramic wick, the wicking element may comprise a porous ceramic. The porous ceramic wick may comprise an open-porous ceramic. A ceramic wick may be rigid. A ceramic wick may not deform when the chamber is in the second configuration.

Preferably, the wicking element may comprise or consist of a resilient material. Such a wicking element may advantageously return to its original shape after being compressed.

The aerosol-generating system may comprise a cartridge. The cartridge may be removably couplable to the aerosol-generating device. The cartridge may comprise a cartridge housing. The cartridge housing may define the reservoir containing an aerosol-forming substrate in condensed form.

The wicking element may be receivable or removable from the receiving chamber when the cartridge is not coupled to the aerosol-generating device. When the cartridge is coupled to the aerosol-generating device, the wicking element may be completely surrounded by the aerosol-generating device and the cartridge.

A cartridge according to the disclosure may advantageously be simple to manufacture and have a low material cost. The cartridge may not comprise the heating element. The cartridge may not comprise a heating element at all. The cartridge may not comprise the wicking element. As such, the material cost and complexity of cartridges according to the disclosure may be lower than for cartridges of the prior art that comprise both a heating element and a porous material, for example cartridges comprising coil and wick type arrangements.

The aerosol-forming substrate contained in the cartridge is a substrate capable of releasing volatile compounds that can form an aerosol. The volatile compounds may be released by heating the aerosol-forming substrate. The aerosol-forming substrate may be solid or liquid or comprise both solid and liquid components. The aerosol-forming substrate may be a gel. The gel may be a solid at room temperature. “Solid” in this context means that the gel has a stable size and shape and does not flow. Room temperature in this context means 25 degrees Celsius.

Preferably, the second aerosol-forming substrate is a liquid.

The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. Preferably, the aerosol-forming substrate may alternatively comprise a non-tobacco-containing material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol and, most preferred, glycerine. The aerosol-forming substrate may comprise other additives and ingredients, such as flavourants.

The aerosol-forming substrate may be adsorbed, coated, impregnated or otherwise loaded onto a carrier or support. The carrier or support may be separate to the wicking element.

The aerosol-forming substrate may be contained in the reservoir. The reservoir may have any suitable shape and size depending on the requirements of the aerosol-generating system.

When the cartridge is coupled to the aerosol-generating device, the wicking element may be in fluidic communication with the aerosol-forming substrate in reservoir.

The cartridge may comprise an opening. The opening may be an opening in the cartridge housing. The opening may be aligned with the wicking element when the cartridge is coupled to the aerosol-generating device. A portion of the wicking element may be received through the opening when the cartridge is coupled to the aerosol-generating.

When the cartridge is coupled to the aerosol-generating device, the wicking element may be in fluidic communication with the aerosol-forming substrate in the reservoir via the opening. The wicking element may therefore advantageously transport aerosol-forming substrate form the reservoir to the heating element.

At least a first portion of the wicking element may extend beyond the receiving chamber when the wicking element is received in the receiving chamber. The first portion of the wicking element may extend beyond the housing of the aerosol-generating device when the wicking element is received in the receiving chamber.

The first portion of the wicking element may be adjacent to, or received through, the opening of the cartridge hosing when the cartridge is coupled to the aerosol-generating device.

If the first portion of the wicking element is received through the opening of the cartridge when the cartridge is coupled to the aerosol-generating device, the first portion of the wicking element may be received in the reservoir of the cartridge.

The reservoir may comprise a carrier or support containing aerosol-forming substrate. The wicking element may contact the carrier or support of the reservoir when the cartridge is coupled to the aerosol-generating device. Aerosol-forming substrate may therefore be transported from the carrier or support to the wicking element.

The cartridge may comprise a seal spanning the opening. The seal may be removable prior to use of the cartridge. Alternatively, the seal may be a breakable seal. The seal may advantageously prevent exposure of the aerosol-forming substrate contained in the reservoir to air. Sealing the reservoir may also prevent leakage of aerosol-forming substrate during transit of the cartridge.

The portion of the wicking element that is received in the receiving chamber may have a shape that corresponds to the shape of the receiving chamber of the heater assembly in which the wicking element is configured to be received. Preferably, the wicking element has an axis symmetric shape. Preferably, the wicking element is cylindrical.

The portion of the wicking element that is received in the receiving chamber may have a length between 3 millimetres and 15 millimetres, preferably between 5 and 10 millimetres.

The wicking element may have a width of between 1 millimeter and 12 millimeters, preferably between 3 millimeters and 7 millimeters. If the wicking element is cylindrical, the values for the width correspond to values for the diameter of the cylindrical wicking element.

The aerosol-generating device may comprise one or more engagement members. The one or more engagement members may be configured to engage corresponding engagement members of the cartridge. The one or more engagement members may be configured such that the aerosol-generating device is configured to engage the cartridge by rotating the aerosol-generating device relative to the cartridge.

The one or more engagement members of the aerosol-generating device may comprise one or more protrusions configured to be received in one or more corresponding slots of the cartridge.

Alternatively or additionally, the one or more engagement members of the aerosol-generating device may comprise one or more slots configured to receive one or more corresponding protrusions of the cartridge.

The one or more engagement members may be configured such that the aerosol-generating device is engaged to the cartridge when the receiving chamber is in the second configuration. The one or more engagement members may be configured to prevent disengagement of the heating element housing from the cartridge when the receiving chamber is in the second configuration. This may prevent damage to the heating element or the wicking element.

The aerosol-generating system may comprise an airflow path extending between an air inlet and an air outlet.

The cartridge may comprise a mouthpiece portion. The mouthpiece portion may be provided on an end of the cartridge that is opposite to the opening.

The air outlet may be formed in the mouthpiece portion of the cartridge. As such, a user of the cartridge may draw air through the airflow path by inhaling through the mouthpiece portion.

At least a portion of the airflow path may extend through the reservoir portion. At least a portion of the airflow path extending through the reservoir portion may be annular in shape. The portion of the airflow path extending through the reservoir portion may be defined by the cartridge housing.

At least a portion of the airflow path may be defined by an outer surface of the wicking element. As such, vapour generated by heating the aerosol-forming substrate contained in the wick may be released directly into air flowing through the airflow path.

When the heating element comprises a coil between a first end a second end, the actuator of the aerosol-generating system may be configured to move or rotate the first end of the coil relative to the second end of the coil for transition of the receiving chamber between the first configuration or second configuration to a third configuration. Preferably, the actuator may be configured to move or rotate the first and second contact portions of the heating element.

When the helical coil is left-handed, the actuator may be configured to rotate the first end of the heating element relative to the second end of the heating element in a clockwise direction for transition of the receiving chamber from the first or second configuration to the third configuration. The actuator may additionally or alternatively be configured to rotate the second end of the heating element relative to the first end of the coil in a counter-clockwise direction for transition of the receiving chamber from the first or second configuration to the third configuration.

When the helical coil is right-handed, the actuator may be configured to rotate the first end of the heating element relative to the second end of the heating element in a counter-clockwise direction for transition of the receiving chamber from the first or second configuration to the third configuration. The actuator may additionally or alternatively be configured to rotate the second end of the heating element relative to the first end of the heating element in a clockwise direction for transition of the receiving chamber from the first or second configuration to the third configuration.

As above, the actuator may be electrically operated and controlled by control circuitry. The control circuitry may be configured to actuate the receiving chamber from the first configuration to the third configuration before actuating the receiving chamber to the second configuration. This may force aerosol-forming substrate out of the wicking element, as described above. The control circuitry may be configured to actuated the receiving chamber from the first configuration to the third configuration before supplying power to the heater assembly to heat the aerosol-forming substrate or at the start of a usage session. As above, this may increase the amount of aerosol that is generated at the start of the puff. The control circuitry is configured to actuate the receiving chamber from the second configuration to the third configuration at the end of a usage session. As above, this may advantageously reduce or minimize cross contamination.

The control circuitry may be configured to actuate the receiving chamber from the third configuration to the second configuration after actuating the receiving chamber from the first configuration to the third configuration. This may be particularly advantageous at the start of a usage session.

The control circuitry may be configured to then actuate the receiving chamber from the second configuration to the third configuration and back to the second configuration. This may advantageously pump the wicking element, as described above. The control circuitry may be configured to repeatedly actuate the receiving chamber from the second configuration to the third configuration and back to the second configuration a plurality of times.

The control circuitry may be configured to actuate the receiving chamber from the third configuration to the first configuration after actuating the receiving chamber from the second configuration to the third configuration. This may be particularly advantageous at the end of a usage session.

According to a second aspect there is a provided a method of using the aerosol-generating system as defined in the first aspect. The method may comprise configuring the receiving chamber in the second configuration. The method may comprise supplying power to the heating element to generate an aerosol from an aerosol-forming substrate.

The step of configuring the receiving chamber in the second configuration may be performed before the step of supplying power to the heating element.

The step of configuring the receiving chamber in the second configuration may comprise transitioning the receiving chamber from the first configuration to the second configuration.

The method may comprise transitioning the receiving chamber from the second configuration to the first configuration after the step of supplying power to the heating element.

The method may comprise the step of coupling the aerosol-generating device and the cartridge. The method may comprise the step of uncoupling the aerosol-generating device and the cartridge.

The method may comprise inserting a wicking element into the receiving chamber when the receiving chamber is in the first configuration. The method may comprise the step of uncoupling the aerosol-generating device and the cartridge before the step of inserting a wicking element into the receiving chamber. The method may comprise the step of coupling the aerosol-generating device and the cartridge after the step of inserting a wicking element into the receiving chamber. The method may comprise at least one of removing or replacing a wicking element from the receiving chamber when the receiving chamber is in the first configuration.

The heating element may comprise a first end, a second end and a coil wound around a central axis. The step of transitioning the receiving chamber may comprise rotating the first end relative to the second.

The method may comprise the step of configuring the receiving chamber in the third configuration.

The step of configuring the receiving chamber in the third configuration may comprise transitioning the receiving chamber from the first configuration to the third configuration. This may be before transitioning the receiving chamber to the second configuration. The step of transitioning the receiving chamber from the first configuration to the third configuration may be before or simultaneously to the step of supplying power to the heating element to generate an aerosol from an aerosol-forming substrate.

The method may comprise the step of repeatedly transitioning the receiving chamber from the third configuration to the second configuration and then back to the second configuration. This step may be repeated a plurality of times.

The step of configuring the receiving chamber in the third configuration may comprise transitioning the receiving chamber from the second configuration to the third configuration. This may be simultaneously with or after the step of supplying power to the heating element to generate an aerosol from an aerosol-forming substrate.

According to a third aspect of the disclosure there is provided a method of controlling an aerosol-generating system as defined in the first aspect. The aerosol-generating device of the aerosol-generating system may comprise an electrically operated actuator controller by control circuitry. The method may comprise configuring the receiving chamber in the second configuration. The method may comprise supplying power to the heating element to generate an aerosol from an aerosol-forming substrate.

The step of configuring the receiving chamber in the second configuration may be performed before the step of supplying power to the heating element.

The step of configuring the receiving chamber in the second configuration may comprise transitioning the receiving chamber from the first configuration to the second configuration.

The method may comprise transitioning the receiving chamber from the second configuration to the first configuration after the step of supplying power to the heating element.

The method may comprise the step of configuring the chamber in the third configuration. The step of configuring the chamber in the third configuration may comprise reconfiguring the chamber from the first configuration to the third configuration. This may be before reconfiguring the chamber to the second configuration. The step of reconfiguring the chamber from the first configuration to the second configuration may be before or simultaneously to the step of supplying power to the first heating element to generate an aerosol from an aerosol-forming substrate.

The method may comprise the step of repeatedly reconfiguring the chamber from the third configuration to the second configuration and then back to the second configuration. This step may be repeated a plurality of times.

The step of configuring the chamber in the third configuration may comprise reconfiguring the chamber from the second configuration to the third configuration. This may be simultaneously with or after the step of supplying power to the first heating element to generate an aerosol from an aerosol-forming substrate.

Features described in relation to one aspect may be applied to other aspects of the disclosure. In particular advantageous or optional features described in relation to the first aspect of the disclosure may be applied to the second or third of the disclosure.

The invention is defined in the claims. However, below there is provided a non-exhaustive list of non-limiting examples. Any one or more of the features of these examples may be combined with any one or more features of another example, embodiment, or aspect described herein.

EX1. An aerosol-generating system for generating an aerosol from an aerosol-generating substrate, the aerosol-generating system comprising:

a heating element;

a receiving chamber at least partially defined by the heating element;

a wicking element received in the receiving chamber; and

wherein the receiving chamber has a first configuration and a second configuration, an internal volume of the receiving chamber being larger when the receiving chamber is in the first configuration than when the receiving chamber is in the second configuration; and

wherein, in the second configuration, the heating element is in contact with the wicking element.

EX2. An aerosol-generating system according to example EX1, wherein the aerosol-generating system comprises a reservoir containing an aerosol-forming substrate in condensed form.

EX3. An aerosol-generating system according to example EX1 or EX2, further comprising an aerosol-generating device and a cartridge, the aerosol-generating device comprising the heating element, the receiving chamber and the wicking element.

EX4. An aerosol-generating system according to example EX3, wherein the device further comprises a power supply.

EX5. An aerosol-generating system according to example EX4, wherein the power supply is electrically connectable to the heating element.

EX6. An aerosol-generating system according to any one of examples EX3 to EX5, wherein the cartridge is removably coupled to the device.

EX7. An aerosol-generating system according to any one of examples EX3 to EX6, comprising a reservoir containing an aerosol-forming substrate in condensed form wherein the cartridge comprises a cartridge housing defining the reservoir.

EX8. An aerosol-generating system according to example EX7, wherein the wicking element is in fluidic communication with the aerosol-forming substrate in the reservoir when the cartridge is coupled to the device.

EX9. An aerosol-generating system according to any one of examples EX3 to EX8, wherein the cartridge further comprises a mouthpiece portion.

EX10. An aerosol-generating system according to any one of examples EX3 to EX9, wherein the cartridge does not comprise a heating element.

EX11. An aerosol-generating system according to any one of the preceding examples, wherein the heating element, in the disengaged position, is not in contact with the wicking element.

EX12. An aerosol-generating system according to any one of the preceding examples, wherein the aerosol-generating system further comprises an airflow path extending between an air inlet and an air outlet.

EX13. An aerosol-generating system according to example EX12, wherein the aerosol-generating system further comprises a heating element housing and the heating element is at least partially contained within the heating element housing.

EX14. An aerosol-generating system according to example EX13, wherein, at least when the receiving chamber is in the second configuration, a portion of the airflow path is defined between the heating element housing and the heating element.

EX15. An aerosol-generating system according to any one of the preceding examples, wherein the receiving chamber further has a third configuration and wherein the internal volume of the receiving chamber is larger in both the first and second configuration than when the receiving chamber is in the third configuration.

EX16. An aerosol-generating system according to example EX15, wherein the internal volume of the receiving chamber is at least 10% larger than when the receiving chamber is in the first configuration.

EX17. An aerosol-generating system according to any one of the preceding examples, wherein the wicking element is removable from the receiving chamber when the receiving chamber is in the first configuration.

EX18. An aerosol-generating system according to any one of the preceding examples, further comprising an actuator configured to actuate the receiving chamber between the first and second configurations.

EX19. An aerosol-generating system according to example EX18, wherein the actuator is electrically operated and controlled by control circuitry.

EX20. An aerosol-generating system according to example EX19, further comprising a power supply and wherein the electrically operated actuator is connected or connectable to the power supply.

EX21. An aerosol-generating system according to example EX19 or EX20, wherein the electric circuitry is configured to operate the actuator to actuate the receiving chamber between the first and second configurations.

EX22. An aerosol-generating system according to example EX21, wherein, following activation of the system at the start of a usage session, the electric circuitry is configured to actuate the receiving chamber from the first configuration to the second.

EX23. An aerosol-generating system according to example EX22, wherein the electric circuitry is further configured to supply power from the power supply to the first heater element following activation of the system at the start of a usage session.

EX24. An aerosol-generating system according to example EX23, wherein the electric circuitry is configured to supply power to the first heater element after actuating the receiving chamber to the second configuration.

EX25. An aerosol-generating system according to example EX23, wherein the electric circuitry is configured to supply power to the first heater element before actuating the receiving chamber to the second configuration.

EX26. An aerosol-generating system according to any one of examples EX22 to EX25, wherein the actuator is further configured to actuate the receiving chamber to a third configuration, the internal volume of the receiving chamber being larger in both the first and second configuration than when the receiving chamber is in the third configuration.

EX27. An aerosol-generating system according to example EX26, wherein the electric circuitry is configured to actuate the receiving chamber from the first configuration to the third configuration before actuating the receiving chamber to the second configuration.

EX28. An aerosol-generating system according to example EX26 or EX27, wherein the electric circuitry is configured to actuate the receiving chamber from the second configuration to the third configuration at the end of a usage session.

EX29. An aerosol-generating system according to any one of the preceding examples, wherein the heating element comprises a coil wound around a central axis.

EX30. An aerosol-generating system according to example EX29, wherein the coil is deformable to reduce the internal volume of the receiving chamber in the second configuration relative to the first configuration.

EX31. An aerosol-generating system according to example EX29 or EX30, wherein the heater assembly further comprises an actuator configured to deform the coil for transition of the receiving chamber from the first configuration to the second configuration.

EX32. An aerosol-generating system according to any one of examples EX29 to EX31, wherein the wicking element is receivable in the receiving chamber in a direction parallel to the central axis.

EX33. An aerosol-generating system according to any one of examples EX29 to EX32, wherein, in the second configuration of the receiving chamber, at least a first portion of the coil contacts the wicking element when the wicking element is received in the receiving chamber.

EX34. An aerosol-generating system according to example EX33, wherein the coil comprises a second portion different to the first portion.

EX35. An aerosol-generating system according to example EX34, wherein, in the second configuration of the receiving chamber, the second portion of the coil does not contact the wicking element when the wicking element is received in the receiving chamber.

EX36. An aerosol-generating system according to example EX34 or EX35, wherein the second portion of the coil comprises a coating material having a resistivity that is lower than a material of the first portion of the coil.

EX37. An aerosol-generating system according to any one of examples EX34 to EX36, wherein the second portion of the coil has a cross-sectional dimension that is larger than the first portion.

EX38. An aerosol-generating system according to any one of examples EX29 to EX37, wherein the coil is a helical coil.

EX39. An aerosol-generating system according to example EX38, wherein the helical coil is axially symmetric.

EX40. An aerosol-generating system according to example EX38 or EX39, wherein the helical coil has a circular cross-section.

EX41. An aerosol-generating system according to example EX40, wherein a diameter of the heating element is larger when the receiving chamber is in the first configuration than when the receiving chamber is second configuration.

EX42. An aerosol-generating system according to any one of examples EX29 to EX41, wherein the heating element comprises a first end and a second end.

EX43. An aerosol-generating system according to example EX42, wherein at least one of the first and second end of the heating element is not in the shape of a coil.

EX44. An aerosol-generating system according to any one of examples EX42 to EX43, wherein the first end is rotatable relative to the second end to reduce the internal volume of the receiving chamber in the second configuration relative to the first configuration.

EX45. An aerosol-generating system according to any one examples EX42 to EX44, wherein the heater assembly further comprises an actuator configured to rotate the first end relative to the second end for transition of the receiving chamber from the first configuration to the second configuration.

EX46. An aerosol-generating system according to any of examples EX29 to EX45, wherein the heating element is a helical coil and wherein the number of turns per unit length of the heating element is greater when the receiving chamber is in the second configuration than when the receiving chamber is in the first configuration.

EX47. An aerosol-generating system according to example EX46, wherein the distance between the first end and the second end of the heating element along the central axis is substantially the same when the receiving chamber is in both the first configuration and the second configuration.

EX48. An aerosol-generating system according to any one of examples EX13 to EX47, wherein the heater assembly further comprises a user interface element configured to actuate the receiving chamber between the first configuration and the second configuration.

EX49. An aerosol-generating system according to example EX48, wherein at least a first portion of the heating element housing forms the user interface element.

EX50. An aerosol-generating system according to example EX49, wherein the heating element comprises a coil wound around a central axis comprising a first end and a second end and wherein the first end of the heating element is fixed to the first portion of the heating element housing.

EX51. An aerosol-generating system according to example EX50, wherein the heating element is not fixed to the first portion of the heating element housing other than at the first end.

EX52. An aerosol-generating system according to any one of examples EX48 to EX51, wherein the heating element housing comprises a second portion and wherein the first portion of the heating element housing is moveable relative to the second portion of the heating element housing.

EX53. An aerosol-generating system according to example EX52, wherein the first portion of the heating element housing is rotatable relative to the second portion of the housing.

EX54. An aerosol-generating system according to example EX52 or EX53, wherein the heating element is a coil wound around a central axis comprising a first end and a second end and the second end of the coil is fixed to the second portion of the heating element housing.

EX55. An aerosol-generating system according to example EX54, wherein the heating element is not fixed to the second portion of the heating element housing other than at the second end.

EX56. An aerosol-generating system according to any one of examples EX52 to EX55, wherein the first and second portions of the housing together form a hollow body containing at least a portion the heating element.

EX57. A method of using the aerosol-generating system as defined in any one of the preceding examples, the method comprising:

configuring the receiving chamber in the second configuration;

supplying power to the at first heating elements to generate an aerosol from an aerosol-forming substrate.

EX58. A method according to example EX57, wherein the step of configuring the receiving chamber in the second configuration is performed before the step of supplying power to the heating element.

EX59. A method according to example EX57 or EX58, wherein the step of configuring the receiving chamber in the second configuration comprises transitioning the receiving chamber from the first configuration to the second configuration.

EX60. A method according to any one of examples EX57 to EX59, further comprising re-configuring the receiving chamber from the second configuration to the first configuration after the step of supplying power to the heating element.

Examples will now be further described with reference to the figures in which:

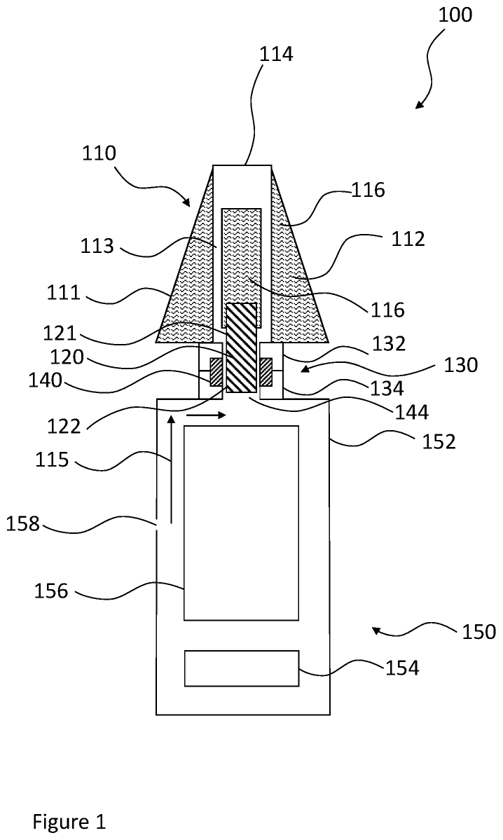

FIG. 1 is a schematic illustration of a first embodiment of an aerosol-generating system comprising an aerosol-generating device and a cartridge, the device comprising a wicking element;

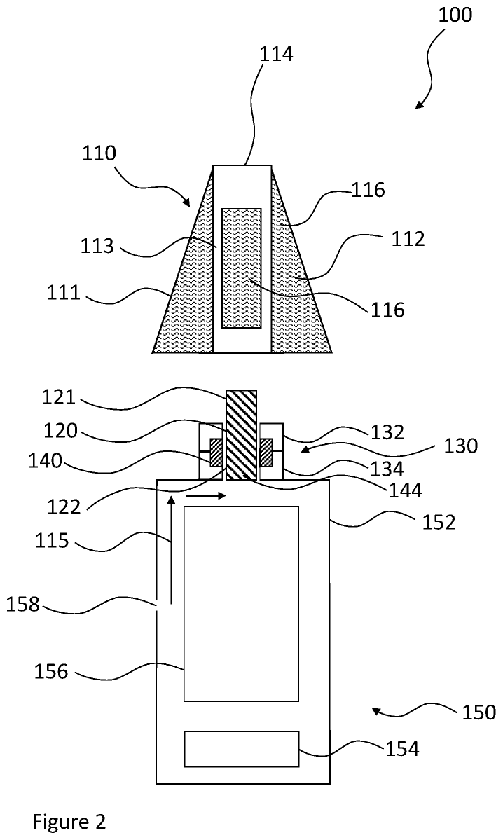

FIG. 2 is a schematic illustration of the first embodiment of the aerosol-generating system of FIG. 1, in which the cartridge is uncoupled from the aerosol-generating device;

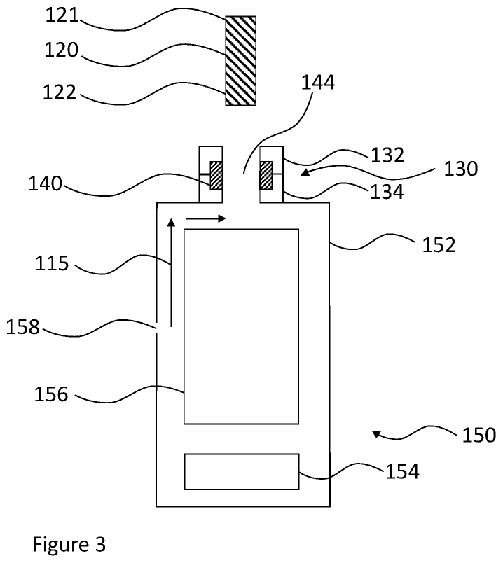

FIG. 3 is a schematic illustration of the first embodiment of the aerosol-generating device of FIGS. 1 and 2, in which the wicking element is removed from the receiving chamber.

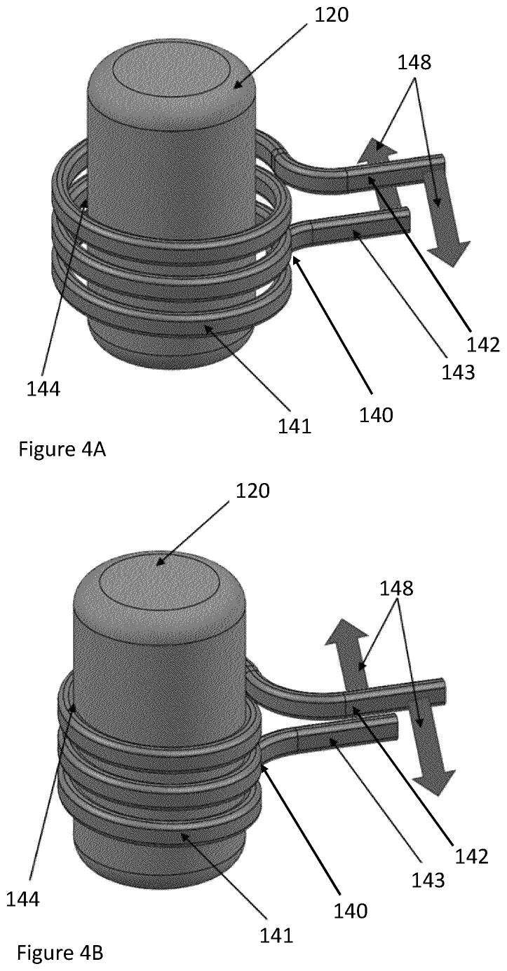

FIGS. 4A and 4B are perspective views of a resistive heating element and a wicking element of the aerosol-generating system of FIG. 1, in FIG. 4A the resistive heating element is uncoupled from the wicking element and in FIG. 4B the resistive heating element is coupled to the wicking element;

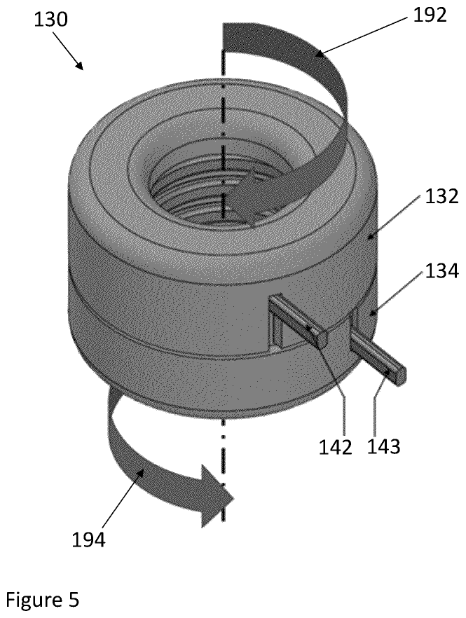

FIG. 5 is a perspective illustration of the heater assembly of the aerosol-generating system of FIG. 1 without a wicking element;

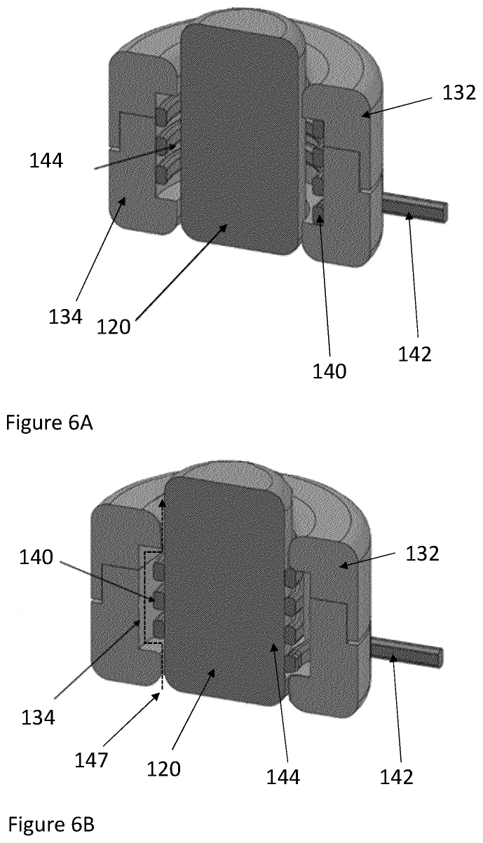

FIGS. 6A and 6B are schematic illustrations of an the heater assembly of the aerosol-generating system of FIG. 1 as well as the wicking element, in FIG. 6A the resistive heating element is uncoupled from the wicking element and in FIG. 6B the resistive heating element is coupled to the wicking element;

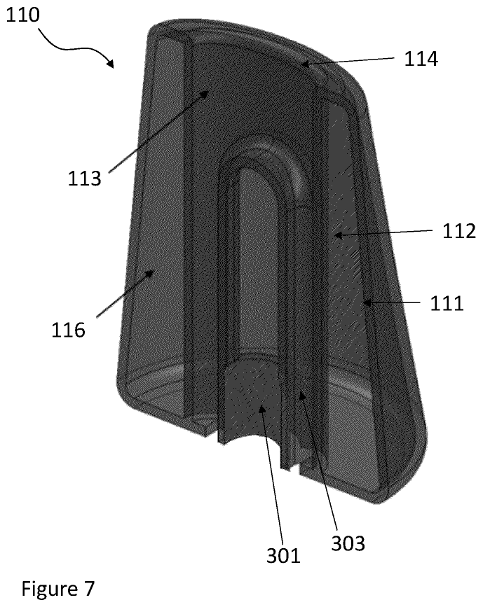

FIG. 7 is a schematic illustration of a cartridge of the aerosol-generating system of FIG. 1;

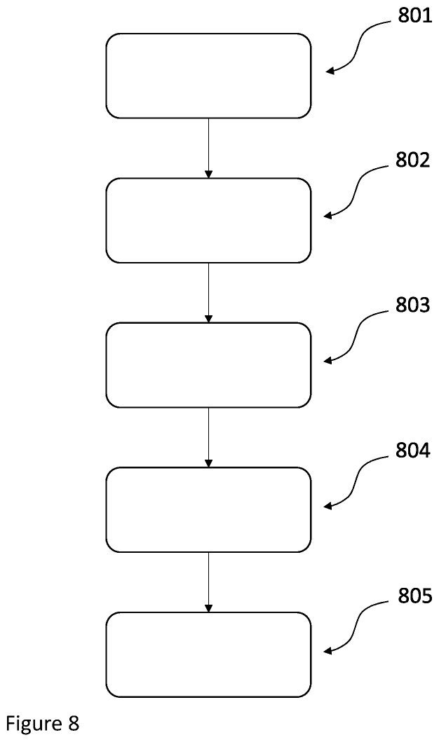

FIG. 8 is a flow chart showing a method of using the aerosol-generating system of FIG. 1; and

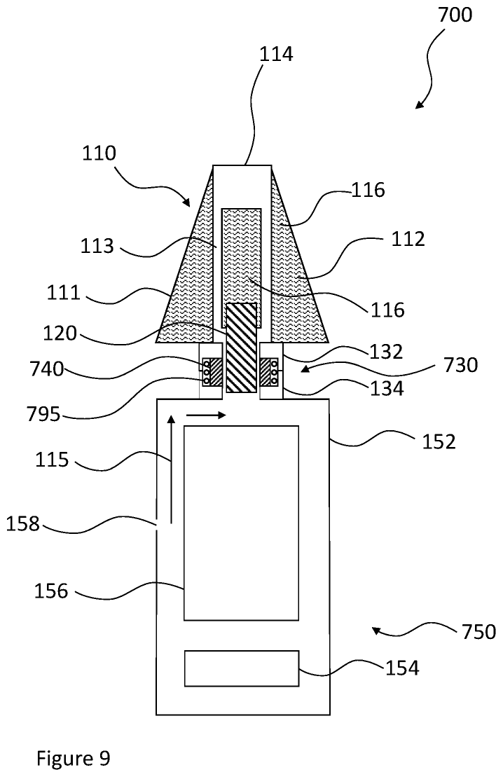

FIG. 9 is a schematic illustration of a second embodiment of an aerosol-generating system according to the disclosure.

FIG. 1 is a schematic illustration of a first embodiment of an aerosol-generating system 100. The aerosol-generating system 100 comprises a cartridge 110. The cartridge 110 comprises a reservoir 112 containing a liquid aerosol-forming substrate 116. The reservoir 112 is defined by the cartridge housing 111. The cartridge 110 further comprises an internal passage 113. A portion of the internal passage 113 is annular. At one end, the cartridge 110 comprises a mouthpiece portion 114.

The aerosol-generating system 100 also comprises an aerosol-generating device 150. The aerosol-generating device 150 comprises a controller 154, and a power supply 156 in the form of a rechargeable battery. A device housing 152 of the aerosol-generating device 150 contains both the controller 154 and the power supply 156. The device housing 152 comprises an air inlet 158, and a device airflow passage 115 extending from the air inlet 158.

The aerosol generating device 150 further comprises a heater assembly 130.

The aerosol-generating device 150 further comprises a wicking element 120. The wicking element 120 is cylindrical in shape.

The heater assembly 130 comprises a resistive heating element 140 configured to heat the wicking element 120. The resistive heating element 140 is formed of a conductive material configured to increase in temperature when a current is passed through it. The resistive heating element 140 comprises a wire wound around a central axis to form a helical coil 141. The helical coil 141 of the resistive heating element 140 defines a receiving chamber 144.

The heater assembly chamber 144 defined by the helical coil 141 of the resistive heating element 140 has two configurations. In a first configuration, the resistive heating element 140 is uncoupled to the wicking element 120. In a second configuration, the resistive heating element 140 is coupled to the wicking element 120. This is shown in FIGS. 4A and 4B as well as FIGS. 6A and 6B. The internal volume of the heater assembly chamber 144 is larger in the first configuration than in the second configuration.

A first portion 121 of the wicking element 120 extends from the heater assembly chamber 144. The first portion 121 of the wicking element 120 comprises a first end.

A second portion 122 of the wicking element 120 of the aerosol-generating device 150 is received within the heater assembly chamber 144, and comprises a second end opposite to the first end of the wicking element.

In FIG. 1, the wicking element 120 is shown in fluidic contact with the liquid aerosol-forming substrate 116 in reservoir 112 of the cartridge 110. In particular, the first end of the wicking element 120 is contained within the cartridge housing 111 and is in fluidic communication with the reservoir 112. The wicking element 120 is receivable into and removable from the cartridge 110 along a longitudinal axis that corresponds to the central axis.

FIG. 2 shows the aerosol-generating system 100 of FIG. 1, but in which the cartridge 110 has been uncoupled from the aerosol-generating device 150. In particular, cartridge 110 has been uncoupled from the heater assembly 130. The wicking element 120 of the aerosol-generating device 150 in FIG. 2 is no longer received in the cartridge 110. The first portion 121 of the wicking element 120 is protruding from the heater assembly 130.

The wicking element 120 is receivable into and removable from the receiving chamber 144 along the central axis. FIG. 3 shows the aerosol-generating device 150 of FIG. 2, but in which the wicking element 120 has been uncoupled and removed from the aerosol-generating device 150. In particular, the second portion 122 of the wicking element 120 has been uncoupled and removed from the heater assembly chamber 144 of the heater assembly 130. For the removal of the wicking element 120 from the heater assembly chamber 144 to be possible, the heater assembly chamber 144 is placed in the first configuration.

FIGS. 4A and 4B are schematic illustrations of the resistive heating element and the wicking element of the first embodiment of the aerosol-generating system.

FIG. 4A shows how the helical coil 141 of the resistive heating element 140 is formed by a wire wound around a central axis to form a helical coil. The heater assembly chamber 144 is defined by the helical coil 141 of the resistive heating element 140. The cylindrical wicking element 120 of the cartridge is received in the heater assembly chamber 140 such that a portion of the wicking element 120 is surrounded by the helical coil 141 of the resistive heating element 140 and is received by the heater assembly chamber 144 defined by the helical coil 141. A first portion of the wicking element 120 protrudes from the heater assembly chamber 144 defined by the helical coil 141. The helical coil 141 shown in FIGS. 4A and 4B is a left-handed helical coil, though the helical coil 141 may alternatively be a right-handed helical coil.

The heater assembly chamber 144 defined by the helical coil 141 has a first configuration and a second configuration. FIG. 4A shows the heater assembly chamber 144 in the first configuration. FIG. 4B shows the heater assembly chamber 144 in the second configuration. As shown in FIGS. 4A and 4B, the internal volume of the receiving chamber 144 defined by the helical coil 141 is larger in the first configuration than in the second configuration. In particular, a cross-sectional area of the heater assembly chamber 144 is larger in the first configuration than in the second configuration but the length of the heater assembly chamber remains substantially constant. The cross-sectional area of the heater assembly chamber 144 is a cross-section of the receiving chamber taken perpendicularly to the helical axis of the helical coil 141.

The pitch of the helical coil 141 is larger when the helical coil is in the first configuration than when the helical coil is in the second configuration. The number of turns per unit length of the helical coil 141 is smaller when the helical coil is in the first configuration than when the helical coil is in the second configuration. However, the length of the helical coil is substantially the same when the helical coil is in the first configuration as when the helical coil is in the second configuration

When the heater assembly chamber is in the first configuration, as shown in FIG. 4A, the resistive heating element 140 is not in contact with the wicking element 120. In other words, the resistive heating element 140 is uncoupled from the wicking element 120 and the wicking element 120 is freely receivable or removable from the heater assembly chamber 144. When the heater assembly chamber 144 is in the second configuration, as shown in FIG. 4B, the resistive heating element 140 is in contact with the wicking element 120. In other words, the resistive heating element 140 is coupled to the wicking element 120.

As is shown in FIGS. 4A and 4B, the resistive heating element 140 comprises a first end 142 and a second end 143. The first and second ends 142, 143 protrude perpendicularly to the central axis of the helical coil 141. The first and second ends 142, 143 comprise a material having a resistance per unit length that is lower than the resistance per unit length of the material of the helical coil 141. The first and second ends 142, 143 therefore advantageously do not heat up as much as the helical coil 141 when power is provided to resistive heating element 140.

The heater assembly chamber 144 is configurable between the first configuration and the second configuration by deforming the resistive heating element 140. In particular, a first pair of opposing rotational forces 148, represented by the arrows at the first and second ends 142, 143 of the resistive heating element 140, can be applied to the first and second ends 142, 143 to reversibly deform the resistive heating element 140, such that the heater assembly chamber 144 is transitionable from the first configuration to the second configuration. A second pair of opposing rotational forces acting in opposite directions to those in the first pair of opposing rotational forces 148, can be applied to the first and second ends 142, 143 to reversibly deform the resistive heating element 140, such that the heater assembly chamber 144 is transitionable from the second configuration to the first configuration.

While FIG. 4A and 4B show how opposing rotational forces 148 are applied to the first and second ends of the resistive heating element 140 to configure the receiving chamber 144, it is possible for transition of the receiving chamber be applying a rotational force to only one of the first or second ends 142, 143. A rotational force applied to only one of the ends of the resistive heating element 140 still causes rotations of one of the first or second ends 142, 143 relative to the other.

As shown in FIG. 1, the heater assembly 130 further comprises an upper actuator element 132 and a lower actuator element 134. The upper and lower actuator elements 132, 134 together form a housing having a hollow body surrounding the heating element 140. The heater assembly, including the upper lower actuator elements 132, 134, is shown separately from the rest of the aerosol-generating system 100 in FIG. 5 which is a schematic perspective illustration. The first end 142 of the resistive heating element 140 is engaged to the upper actuator element 132. In particular, the first end 142 of the resistive heating element 140 passes through an aperture defined in the upper actuator element 132. The second end 143 of the resistive heating element 140 is engaged to the lower actuator element 134. In particular, the second end 143 of the resistive heating element 140 passes through an aperture defined in the lower actuator element 134.

The upper actuator element 132 is axially rotatable relative to the lower actuator element 134. In particular, the actuator element 132 is axially rotatable relative to the lower actuator element 134 about the helical axis of the heating element which is represented by the broken line FIG. 3. By rotating the upper actuator element 132 relative to the lower actuator element 134, the first end 142 of the resistive heating element 140 is rotated relative to the second end 143 to elastically deform the resistive heating element 140 and transition the receiving chamber 144 between the first and second configurations. The rotational forces applied to upper and lower actuator elements 132, 134 for transition of the receiving chamber 144 between the first and second configurations are shown by arrows 192, 194 respectively. While FIG. 3 shows both lower and upper actuator elements 132, 134 as being rotatable, it is enough for only one of the actuator elements to be rotatable relative to the other.

FIG. 6A shows a schematic cross-section of the heater assembly of FIG. 5 but in which the wicking element 120 is received in the heater assembly chamber 144. In FIG. 6A, the heater assembly chamber 144 is in the first configuration. The upper actuator element 132 and the lower actuator element 134 surround the resistive heating element 140. The second end portion 143 protrudes out of the lower actuator element 134. As FIG. 6A is a cross-sectional view, only the second end portion 143 is visible.

FIG. 6B shows the heater assembly with the heater assembly chamber 144 in the second configuration. As in FIG. 4B, the wicking element 120 is received in the heater assembly chamber in the second configuration 146, and the resistive heating element 140 is contacting the wicking element 120. An air flow path 147 is defined by the annular space between the helical coil 141 and the lower actuator element 134 and then between the helical coil 141 and the upper actuator element 132. The annular space itself between the helical coil 141 and the lower actuator element 134 and then between the helical coil 141 and the upper actuator element 132 defines an aerosol generating chamber in which aerosol is first generated to before delivery to the user.

FIG. 7 shows a schematic illustration of the cartridge 110 separately from the aerosol-generating device. A cavity 301 is defined by an internal wall 303. The cavity 301 is approximately cylindrical. The cavity 301 comprises a first circular opening at the end of the cartridge distal to the mouthpiece 114. The cavity 301 comprises a second circular opening to the reservoir 112, the second circular opening diametrically opposed to the first circular opening. The internal wall 303 is integrally formed with the cartridge housing 111. The reservoir 112 is defined by the cartridge housing 111. The internal passage 113 is defined by the cartridge housing 111 and the wicking element wall 303.

Cartridge 110 is configured such that when the cartridge 110 is coupled to the aerosol-generating device 150, the first portion 121 of the wicking element 120 is received in the cavity 301 of the cartridge 110. The first portion 121 of the wicking element 120 is received in the cavity 301 through the first circular opening. Cartridge 110 is configured such that when the wicking element 120 is received in the cavity 301 of the cartridge 110, the first end of the wicking element 120 is in fluidic communication with the liquid aerosol-forming substrate 116 contained in the reservoir 112.

FIG. 8 shows a schematic of a first method of using the aerosol-generating system 100. The method comprises the step 801 of receiving the wicking element 120 in the heater assembly chamber 144 in the first configuration. As above, in the first configuration, the wicking element 120 is freely receivable and removable from the resistive heating element 140 in the first configuration, the wicking element 120 and the resistive heating element 140 are not coupled. So it is straightforward to receive the wicking element 120 the heater assembly chamber 144 when the heater assembly chamber 144 is in the first configuration.

The method further comprises step 802 of coupling the cartridge 110 with the aerosol-generating device 150. The first portion 121 of the wicking element 120 is received in the cavity 301 of the cartridge 110. The wicking element 120 is in fluidic communication with the liquid aerosol-forming substrate 116.

The method further comprises step 803 of rotating a first end 142 of the resistive heating element 140 relative to a second end 143 of the resistive heating element 140 so as to deform the resistive heating element 140 such that the resistive heating element 140 is in contact with the wicking element 120. The wicking element 120 is therefore in the heater assembly chamber 144 in the second configuration. In step 803 the heater assembly chamber 144 is therefore transitioned from the first configuration to the second configuration.

The method further comprises step 804 of using the aerosol-generating system 100 while the heater assembly chamber 144 is in the second configuration. The step 803 of transitioning the heater assembly chamber 144 from the first configuration to the second configuration automatically sends an activation signal to the controller 154 to activate the device 150. Activation of the device 150 results in power being supplied from the battery 156 to the resistive heating element 140. The battery 156 is connected to the first and second ends 142, 143 of the resistive heating element 140 via wires and suitable electrical contacts, not shown in the figures. This causes a current to flow through the resistive heating element 140, thereby resistively heating the resistive heating element 140.

In other examples, the device 150 is not activated immediately in response to the heater assembly chamber 144 being transitioned from the first configuration to the second configuration. Instead a user may press a button (not shown) on the aerosol-generating device 150 which sends the activation signal to the controller 154. In other examples, an air flow sensor, or pressure sensor, is located in the aerosol-generating system 100 and electrically connected to the controller 154. The air flow sensor, or pressure sensor, detects that a user is puffing on the mouthpiece portion 114 and sends a signal to the controller 154 to provide power to the resistive heating element 140.

During step 804, a user can puff on the mouthpiece portion 114 of the cartridge 110. As the user puffs on the mouthpiece portion 114 of the cartridge 110, air is drawn into the air inlet 158. An airflow path is defined between the air inlet 158 and the mouthpiece portion 114, passing through the device airflow passage 115, the heater assembly 130, and the internal passage 113 of the cartridge 110. In particular, the airflow path passes over the wicking element 120. Liquid aerosol-forming substrate 116 in the reservoir 112 is drawn into the wicking element 120 by capillary forces. The liquid aerosol-forming substrate 116 in the wicking element 120 is subsequently heated and vaporised by the resistive heating element 140 to generate a vapour. The airflow entrains the vapour formed by the resistive heating element 140 heating liquid aerosol-forming substrate 116 in the wicking element 120. This entrained vapour then cools and condenses to form an aerosol. This aerosol is subsequently drawn out of the system via the internal passage 113 of the cartridge 110 and the mouthpiece portion 114 by the user.

Because the resistive heating element 140 is in contact with the wicking element 120 in the second configuration, the wicking element 120 (and so the liquid aerosol-forming substrate 116) is efficiently heated by the resistive heating element 140.

The method further comprises the fifth step 805 of transitioning the heater assembly chamber 144 from the second configuration to the first configuration. After the fifth step 805, the resistive heating element 140 is decoupled from the wicking element 120. Following step 805, the cartridge 110 may be decoupled from the aerosol-generating device and replaced. This may be advantageous if the liquid aerosol-forming substrate 116 of the cartridge 110 is depleted. Additionally, after the cartridge is decoupled from the aerosol-generating device, the wicking element 120 can be removed from the aerosol-generating device 150 and replaced. This is advantageous if the wicking element 120 is degraded or damaged. Alternatively or additionally, the steps 803 to 805 can be repeated for subsequent usage sessions until the liquid aerosol-forming substrate 116 of the cartridge 110 is depleted.

The heater assembly chamber 144 has been described as having a first configuration and a second configuration. The heater assembly chamber 144 also has a third configuration (not shown in the Figures). In the third configuration, the receiving chamber 144 has a smaller internal volume than in both the first and the second configuration. In some embodiments, the wicking element 120 comprises a compressible material. So, in the third configuration, the wicking element compressible material is compressed.

Thus, in some embodiments, step 803 of the method comprises rotating a first end 142 of the resistive heating element 140 relative to a second end 143 of the resistive heating element so as to deform the heating element such that the receiving chamber is in the third configuration and then rotating a first end 142 of the resistive heating element 140 relative to a second end 143 of the resistive heating element so as to deform the resistive heating element such that the resistive heating element is in contact with the wicking element.

Configuring the heater assembly chamber 144 in the third configuration before the second configuration forces aerosol-forming substrate contained in the wicking element 120 outside of the wicking element 120. This aerosol-forming substrate is then quickly heated and vaporised during step 804.

FIG. 9 shows a schematic illustration of an aerosol-generating system 700 in accordance with the present invention. The aerosol-generating system 700 is similar to that shown in FIG. 1, so will only be described with respect to the differing features only. The heater assembly 730 of the aerosol generating device 750 further comprises an inductor coil 795. Instead of a resistive heating element, heater assembly 730 of aerosol generating device 750 further comprises a susceptor element 740. The susceptor element 740 comprises a helical susceptor coil in the same form as the helical coil 141 of resistive heating element 140 in FIGS. 1 to 6, including comprising end portions protruding through upper actuator element 132 and lower actuator element 134. Instead of being directly resistively heated however, the susceptor element 740 is heated by induction. Alternating currents are applied to inductor coil 795, which generates a magnetic field. The susceptor element 740 is heated by eddy currents and hysteresis losses induced by the generated magnetic field.

1.-15. (canceled)

16. An aerosol-generating system for generating an aerosol from an aerosol-generating substrate, the aerosol-generating system comprising:
a heating element;
a receiving chamber at least partially defined by the heating element;
a wicking element received in the receiving chamber,
wherein the receiving chamber has a first configuration and a second configuration, an internal volume of the receiving chamber being larger when the receiving chamber is in the first configuration than when the receiving chamber is in the second configuration, and wherein, in the second configuration, the heating element is in contact with the wicking element; and
an actuator comprising a user interface element and an actuation mechanism, the actuation mechanism being configured to actuate the receiving chamber between the first configuration and the second configuration in response to an input on the user interface element.

17. The aerosol-generating system according to claim 16,
further comprising an aerosol-generating device and a cartridge, the aerosol-generating device comprising the heating element, the receiving chamber, and the wicking element,
wherein the cartridge is removably couplable to the aerosol-generating device.

18. The aerosol-generating system according to claim 17, wherein the aerosol-generating device further comprises a power supply.

19. The aerosol-generating system according to claim 17,
further comprising a reservoir containing an aerosol-forming substrate in condensed form,
wherein the cartridge comprises a cartridge housing defining the reservoir.

20. The aerosol-generating system according to claim 19, wherein the wicking element is in fluidic communication with the aerosol-forming substrate in the reservoir when the cartridge is coupled to the aerosol-generating device.

21. The aerosol-generating system according to claim 17, wherein the cartridge does not comprise a heating element.

22. The aerosol-generating system according to claim 17, wherein at least a first portion of the wicking element extends beyond the receiving chamber when the wicking element is received in the receiving chamber.

23. The aerosol-generating system according to claim 22,
further comprising a reservoir containing an aerosol-forming substrate in condensed form,
wherein the cartridge comprises a cartridge housing defining the reservoir,
wherein the cartridge housing defines an opening, and
wherein the first portion of the wicking element is adjacent to, or received through, the opening of the cartridge housing when the cartridge is coupled to the aerosol-generating device.

24. The aerosol-generating system according to claim 16, wherein the actuation mechanism is configured to convert a motion of the user interface element during an input to move or to deform the heating element.

25. The aerosol-generating system according to claim 16, wherein the heating element is moveable or deformable to reduce the internal volume of the receiving chamber in the second configuration relative to the first configuration.

26. The aerosol-generating system according to claim 16,
wherein the heating element comprises a coil, and
wherein the actuator is configured to deform the coil for transition of the receiving chamber from the first configuration to the second configuration.

27. The aerosol-generating system according to claim 26,
wherein the heating element further comprises a first end and a second end, and
wherein the actuator is configured to rotate the first end relative to the second end for transition of the receiving chamber from the first configuration to the second configuration.

28. The aerosol-generating system according to claim 26, wherein the coil is a helical coil.

29. A method of operating the aerosol-generating system according to claim 16, the method comprising:
configuring the receiving chamber in the second configuration; and
supplying power to the at first heating elements to generate the aerosol from the aerosol-forming substrate.

30. The method according to claim 29, further comprising reconfiguring the receiving chamber from the second configuration to the first configuration after the step of supplying power to the heating element.
